(19) United States
(12) Patent Application Publication
(10) Pub. No.: US 2020/0295801 A1
(43) Pub. Date: Sep. 17, 2020

(54) WALL PLATE DATA/POWER EXCHANGE SYSTEM

(71) Applicant: Keith Cyzen, Glen Ellyn, IL (US)

(72) Inventor: Keith Cyzen, Glen Ellyn, IL (US)

(21) Appl. No.: 16/817,127

(22) Filed: Mar. 12, 2020

Related U.S. Application Data
(60) Provisional application No. 62/817,149, filed on Mar. 12, 2019.

(51) Int. Cl. H04B 3/54; H01R 24/76; H01R 24/20

(52) U.S. Cl. CPC H04B 3/542; H01R 24/20; H01R 24/76

(57) ABSTRACT

Wall plates having integrated charging and/or data exchange components are described herein. The wall plates include a rearwardly protruding outlet connector to electrically couple the charging components with an electrical outlet and a data and/or power exchanging device. The data and/or power exchanging device can provide a wired or wireless connection to perform data exchanging functions and/or to charge the power source of a portable electronic device.

### CROSS-REFERENCE TO RELATED APPLICATION

This application claims the benefit of U.S. Provisional Application No. 62/817,149, filed Mar. 12, 2019, which is hereby incorporated by reference herein in its entirety.

### FIELD OF THE DISCLOSURE

The present disclosure generally relates to data and/or power transfer mechanisms, such as wires/cables (“cord” or “cords”) and plugs for electronic devices and, more particularly, to cord retention solutions used with sources of data and/or power.

### BACKGROUND

Cords that have been designed for and/or are utilized to connect one or more portable electronic devices (“PED” or “PEDs”), such as but not limited to mobile phones, have indeed taken on many forms with advances in technology. In one current form, a cord includes a connector at a first end thereof that is configured to connect to a PED and another connector at a second end to connect to a data I/O port and/or power I/O port (“data/power port”) and/or second electronic device. One common connector for the second end can be a Universal Serial Bus (USB) connector that allows the PED to be connected to a data/power port having a corresponding port connector technology (“plug” or “plugs”). The USB connector can also be utilized in conjunction with a coupler or electronic coupling device such as, but not limited to a USB AC adapter to connect the PED into a data/power port to perform data exchanging functions and/or to charge the PED and/or devices connected to the data/power port. Unfortunately, with the increase in connections, the chance that one of the connections is inadvertently separated increases.

### SUMMARY

In accordance with one aspect, a wall plate charging system is disclosed that includes a wall plate having a plate portion with a generally planar configuration and a housing portion extending from the plate portion. The system further includes a data and/or power exchanging assembly at least partially disposed within the housing portion and permanently coupled thereto, the assembly including an outlet connector projecting rearwardly through one or more openings in a back surface of the housing and a data and/or power exchanging device.

According to some forms, the outlet connector can be a one or multi-prong plug, a USB connector, a fiber optic connector, and/or a magnetic data exchange connector.

According to some forms, the wall plate can include a socket opening, where the housing and socket opening are configured to align with respective sockets of an electrical outlet; the wall plate can include a fastener opening extending therethrough to secure the wall plate to an electrical outlet or structure adjacent to an electrical outlet; and/or the data and/or power exchange assembly can include at least one of a converter, a switch mode power supply, a data transducer, a power transducer, a photovoltaic power supply, or a kinetic power supply.

According to some versions, the data and/or power exchange device can be a cord having a distal connector that projects forwardly from an opening in a front surface of the housing. In one form, the system can include a cord protector that is mounted to the housing around the opening in the front surface. In another form, the housing portion can project forwardly from the plate portion and can include a flange that projects outwardly from a sidewall thereof. Further, a front surface of the flange can be planar with the front surface of the housing and/or the flange can include one or more slot openings sized to frictionally receive a portion of the cord therein.

According to other versions, the data and/or power exchange device can be a transmitter coil that is disposed within the housing portion and has a main surface extending generally parallel with a charging surface of the housing portion. In one form, the housing portion can extend forwardly from plate portion in a generally horizontal orientation such that the charging surface faces upwardly to receive a PED thereon. In other forms, the housing portion can extend upwardly from the plate portion and, if desired, at a rearward angle with respect to a vertical axis of the plate portion. In these forms, the wall plate can include a ledge that extends forwardly from the housing portion to receive a PED thereon.

### BRIEF DESCRIPTION OF THE DRAWINGS

The above needs are at least partially met through provision of the embodiments described in the following detailed description, particularly when studied in conjunction with the drawings, wherein:

FIG. 1 is a front perspective view of a first example wall plate charging system in accordance with various embodiments;

FIG. 2 is a rear perspective view of the wall plate charging system of FIG. 1;

FIG. 3 is a front perspective view of a second example wall plate charging system in accordance with various embodiments;

FIG. 4 is a rear perspective view of the wall plate charging system of FIG. 3;

FIG. 5 is a front perspective view of a third example wall plate charging system in accordance with various embodiments.

### DETAILED DESCRIPTION

Wall plates having integrated charging components are described herein. The wall plates include a rearwardly protruding outlet connector to electrically couple the charging components with an electrical outlet and a charging device. In some versions, the charging device can include a wired or wireless connection. The wall plates can be secured to the electrical outlets or structure adjacent thereto to thereby retain the charging components in electrical engagement with the electrical outlets. The wall plates can be secured to the structure using any suitable mechanism, such as by using fasteners, snap fit, and so forth.

In one form, the charging components can include one or more data and/or power cord or cords that extend outwardly from the wall plate so that a user can physically connect one or more PEDs to the charging components. In another form, the charging components can include a transmitter coil and associated components configured to inductively charge a PED disposed adjacent to the wall plate. The charging components can include any circuitry to modify voltage and power and/or data and data exchange protocol to a form suitable for a particular PED. In either form, the wall plate is secured to a wall or other substrate to thereby prevent one from walking away from the wall with a charging device.

While the depicted forms are designed and configured to accommodate standard one prong or multi-prong electrical outlets, such as two or three prong electrical outlets, the embodiments described herein could be easily modified to accommodate smaller USB connectors, fiber optic connectors, magnetic data exchange connectors, or other suitable plugs. That is, due to the proliferation of PEDs and the need for electrically charging these devices, recent trends in data and/or electrical supply include providing wall power outlets (i.e., electrical sockets) with a USB or other plug connector port in addition to or as a substitute for one of the traditional prong electrical outlets, such as one, two, or three prong electrical outlets. This advantageously enables users to plug the first end of the charging cord directly into the particular outlet without requiring separate adapter circuitry or components. Thus, it should be appreciated that the present invention can be easily modified to accommodate this simple variation.

As shown in various ones of the figures, the charging and data exchange systems and methods described herein are configured to perform data and/or power exchange functionalities for a suitable PED 50, such as a smart phone, tablet, e-reader, and the like. The PED 50 includes electronic components powered and/or instructed by a respective power/data source 52 that can receive data and/or power through a wired connection from a data and/or power supply to a port 54 or through an induction connection from a data and/or power supply transmitter coil, described in more detail below, to a coil 56 as commonly understood. As shown, the coil 56 has a disk-shaped configuration with main surfaces 58 that extend in a direction generally parallel with respect to main surfaces 60 of the device 50.

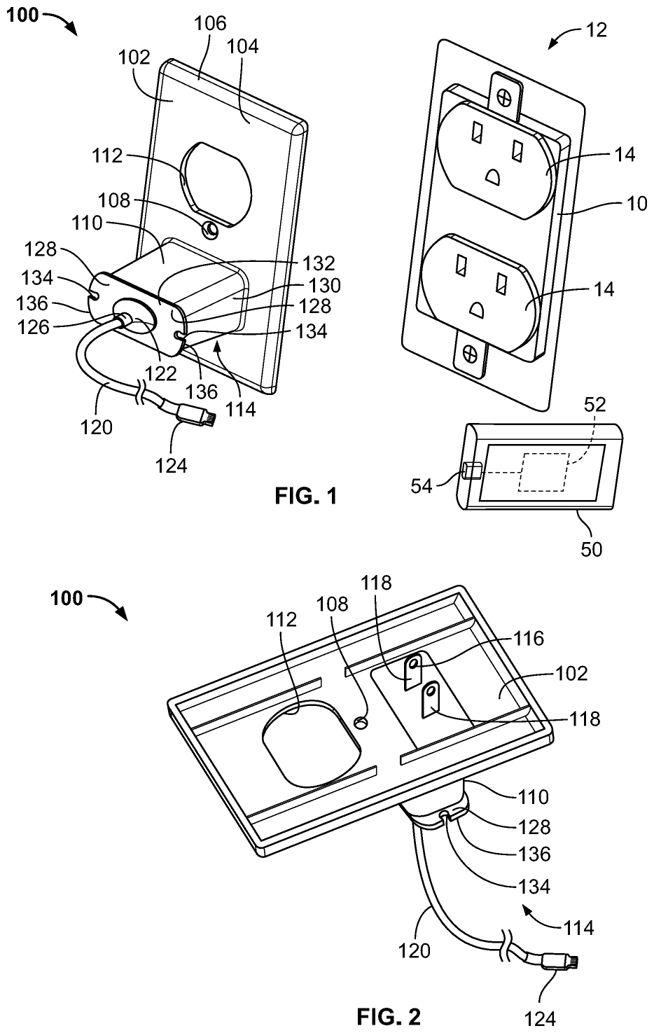

Referring now to the figures, a corded embodiment of a data/power port wall plate system 100 is in FIGS. 1 and 2. The system 100 includes a wall plate or outlet cover 102 having a generally planar plate portion 104 with, optionally, a beveled or tapered edge 106 as shown. The wall plate 102 is configured to be secured adjacent to an electrical outlet 10, such as to structure of the outlet 10, a junction box, a wall 12 extending around the outlet 10, and so forth, by any suitable mechanism. For example, the wall plate 102 can be secured using one or more fasteners, having any desired drive type, such as square, hex, slotted, Phillips, Torx, spline, and the like, extending through an opening 108 in the plate portion 104. Alternatively, the wall plate 102 can include snap fit, tongue-and-groove, plug, latch, magnetic, and/or threaded structure.

In the illustrated form, the wall plate 102 further includes an exchange housing 110 and an opening 112 sized to extend around a socket 14 of the outlet 10. The housing 110 and opening 112 are spaced from one another to align with the sockets 14 of the outlet 10. Although a two socket wall plate 102 is shown, additional housings 110 and/or openings 112 can be provided for outlets having sockets in larger or smaller arrays. In another embodiment, the wall plate 102 can include two or more housings 110 in place of one or more of the openings 112.

A power and/or data exchange assembly 114 of the system 100 includes an outlet connector 116 that projects rearwardly from the housing 110 through rear openings 118 to electrically couple with a socket 14 and an exchange device 120. As shown, the outlet connector 116 can be prongs, but other suitable forms include USB connectors, fiber optic connectors, magnetic data exchange connectors, and so forth. In this form, the exchange device 120 is a cord that projects forwardly from the housing 110 through a front opening 122 to a connector 124 so that the system 100 provides a wired connection with the PED 50. In some versions, the wall plate 102 can include a cord protection extension 126 that extends around a portion of the cord 120 adjacent to the housing 110. The cord connector 124 can be adapted to be inserted into the port 54 of the PED 50 to thereby electrically couple the device 50 to the power supply from the outlet 10 to charge the power source 52. This configuration allows data and/or energy to flow both to and from the PED 50 and the system 100. The energy can be obtained and transferred by any suitable methods, including a grid power supply, solar energy, kinetic energy, and so forth.

According to other forms, the outlet connector 116 may be inter-connected by conventional male/female mechanical friction and/or by latch as is seen with, but not limited to, the CAT 5 connector type. Additionally or alternatively, the outlet connector 116 may be connected by proximity such as, but not limited to, magnetic coupling with data and/or power being transferred via mechanical, biological, chemical, optical, thermal, radio, radioactive and/or electrical transduction.

In some versions, cords 120 can be utilized that perform some of the same functions as traditional cords, but by different mechanical, biological, chemical, optical, thermal, radio, radioactive and/or electrical means.

The housing 110 can be sized to accommodate any circuitry and/or electrical components to transfer and/or condition the power and/or data from the outlet 10 to the cord 120 for powering, charging, and/or exchanging data with a PED 50. In one version, the assembly 114 can include converter circuitry to convert an AC power supply to a DC output, such as a 120 VAC or 240 VAC to a 5 VDC output. For example, the assembly 114 can include a step down transformer, rectifying circuits, filter circuits, transduction circuits, and/or regulator circuits. In another version, the assembly 114 can include a switch mode power supply, including the various components thereof. For example, the assembly 114 can include an input rectifier and filter, an inverter with high frequency signal and switching devices, a power transformer, a transducer, an output rectifier and filter, and/or a feedback system and circuit control. In other versions, the assembly 114 can include a data and/or power transducer, a photovoltaic power supply, or a kinetic power supply. For example, the assembly 114 can include any suitable wind-up, spring, or centripetal energy mechanisms. Additionally, for any of the above versions, the system 100 can connect the PED 50 with a second electronic device, such as a second PED. With this connection, the second PED can share data and/or power with the PED 50. For example, a kinetic or other power supply can supply power to the PED 50 through the system 100. In one specific example, the system 100 can be utilized to electrically couple the PED 50 with a second PED, such as a smart watch or other energy generating device, and the second PED can provide charging power to the PED 50 through the system 100. If desired, any excess power within the system 100 can be sold back to the power grid.

While the housing 110 is shown projecting forwardly a significant amount from the plate portion 104, in other forms, the housing 110 can have a reduced depth with respect to the plate portion 104, including having the same depth such that the housing 110 is planar with respect to an outer surface of the plate portion 104, having twice the depth of the plate portion 104, and so forth.

The system 100 can be formed using any suitable method. For example, the wall plate 102 can be formed over and around the components of the assembly 114, including the prongs 116 and cord 120, using an injection molding or 3D printing system. In another version, the wall plate 102 can be formed with the openings 118, 122 and a cavity in the housing 110 sized to receive components of the assembly 114 therein by any suitable method, including injection molding, 3D printing, blow molding, reductive assembly, and so forth. After the charging assembly is installed, the cavity can be closed off in a permanent manner with a housing piece by any suitable method, such as by adhesive, ultrasonic welding, and so forth. It will be understood that either method of formation can be utilized to create a system having an integral charging assembly. In other words, the housing can be integrally formed with the assembly 114 or can permanently receive the assembly 114 therein so that the components of the assembly 114 cannot be separated from the housing.

As shown in FIGS. 1 and 2, the housing 110 can further include a flange 128 that projects outwardly from all or portions of a sidewall 130 of the housing 110, such as in a plane generally parallel with the plate portion 104. In the illustrated form, the flange 128 projects from the sidewall 130 of the housing 110 aligned with a front surface 132 thereof. Of course, the flange 128 can be disposed at other depths of the housing 110. The flange 128 can provide a convenient finger grip for a user to hold the wall plate 102. Moreover, the flange 128 can advantageously include one or more slot openings 134 extending therethough and accessible through an edge 136 thereof. In the illustrated form, the flange 128 includes lateral portions extending from sides of the housing 110 and the slot openings 134 open laterally through the edges 136 of the flange 128. The slot openings 134 can be sized to receive the cord 120 therein in a friction fit. So configured, the portions of the cord 120 extending from the wall plate 102 can be wrapped around the housing 110 and the flange 128 and the slot openings 134 can be utilized to retain the cord 120 in the wrapped configuration.

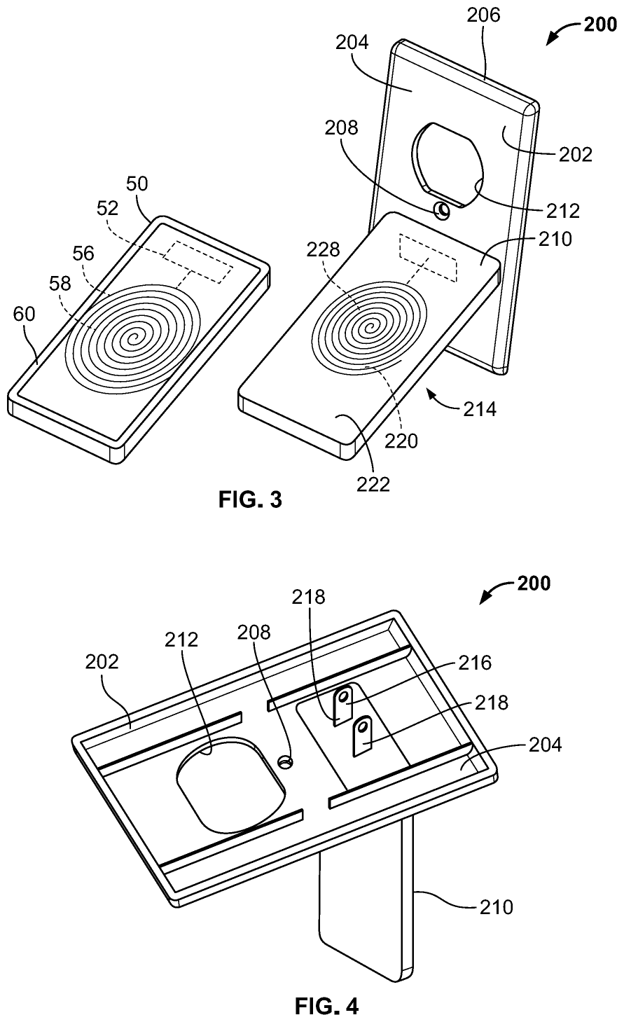

A wireless embodiment of a charging wall plate system 200 is shown in FIGS. 3 and 4. The system 200 includes a wall plate or outlet cover 202 having a generally planar plate portion 204 with, optionally, a beveled or tapered edge 206 as shown. The wall plate 202 is configured to be secured adjacent to an electrical outlet 10, such as to structure of the outlet 10, a junction box, a wall 12 extending around the outlet 10, and so forth, by any suitable mechanism. For example, the wall plate 202 can be secured using one or more fasteners, having any desired drive type, such as square, hex, slotted, Phillips, Torx, spline, and the like, extending through an opening 208 in the plate portion 204. Alternatively, the wall plate 202 can include snap fit, tongue-and-groove, plug, latch, magnetic, or threaded structure.

In the illustrated form, the wall plate 202 further includes a charging housing 210 and an opening 212 sized to extend around a socket 14 of the outlet 10. The housing 210 and opening 212 are spaced from one another to align with the sockets 14 of the outlet 10. Although a two socket wall plate 202 is shown, additional housings 210 and/or openings 212 can be provided for outlets having sockets in larger or smaller arrays. In another embodiment, the wall plate 202 can include two or more housings 210 in place of one or more openings 212.

A wireless charging assembly 214 of the system 200 includes an outlet connector 216, prongs in the illustrated embodiment, that projects rearwardly from the housing 210 through rear openings 218 to electrically couple with a socket 14 and a charging device 220. In this form, the charging device 200 is a transmitter coil that extends within the housing 210 along a length thereof. If desired, the assembly 214 can include shielding to shield components of the assembly 214 and/or outlet 10.

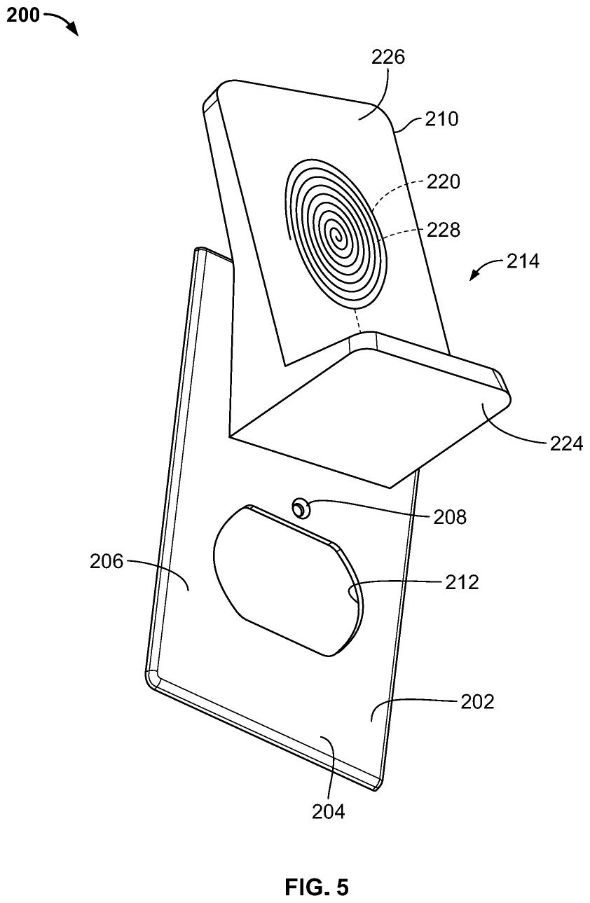

In a first form shown in FIGS. 3 and 4, the housing 210 can project forwardly, e.g., in a generally perpendicular orientation, from the plate portion 104. With this configuration, the wall plate 102 can be secured to or around an outlet 10 and the housing 210 will extend horizontally from the outlet 10 presenting an upwardly facing charging surface 222 that a user can place a PED 50 on to exchange data with and/or charge the power source 52 thereof. Specifically, the user can position the device 50 on the charging surface 222 to align the coil 56 with the transmitter coil 220 to receive data and/or charging power therefrom. In another form as shown in FIG. 5, the housing 210 can project upwardly, e.g., generally parallel with or at a rearward angle with respect to, from the plate portion 104. In this form, the wall plate 202 can further include a ledge or shelf 224 that projects outwardly from the housing 210. With this configuration, a user can rest a PED 50 on the ledge 224 and the device 50 will extend along a forwardly facing charging surface 226 of the housing 210 to align with the transmitter coil 220 to exchange data and/or charge the power source 52 of the device 50. Specifically, positioning the device 50 on the ledge 224 aligns the coil 56 with the transmitter coil 220 in the housing 210 to receive data and/or charging power therefrom. As shown, main surfaces 228 of the transmitter coil 220 extend generally parallel to the charging surface 222, 226 so positioning the PED 50 thereon aligns the coil 56 within the device 50 with the transmitter coil 220.

The housing 210 can be sized to accommodate any circuitry and/or electrical components to transfer and/or condition the data and/or power from the outlet 10 to the transmitter coil 220 for data exchange, powering and/or charging a PED. Accordingly, while the housing 210 is shown having portions projecting forwardly from the plate portion 204, in other forms, the housing 210 can have the same depth such that an outer surface of the housing 210 is planar with respect to an outer surface of the plate portion 204.

The system 200 can be formed using any suitable method. For example, the wall plate 202 can be formed over and around the components of the charging assembly 214, including the prongs 216, using an injection molding or 3D printing system. In another version, the wall plate 202 can be formed with the openings 218 and a cavity in the housing 210 sized to receive components of the charging assembly 214 therein by any suitable method, including injection molding, 3D printing, blow molding, reductive assembly, and so forth. After the charging assembly is installed, the cavity can be closed off in a permanent manner with a housing piece by any suitable method, such as by adhesive, ultrasonic welding, and so forth. It will be understood that either method of formation can be utilized to create a system having an integral charging assembly. In other words, the housing can be integrally formed with the charging assembly 114 or can permanently receive the charging assembly 214 therein so that the components of the assembly 214 cannot be separated from the housing.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A wall plate system comprising:
a wall plate having a plate portion with a generally planar configuration and a housing portion extending from the plate portion;
a data and/or power exchanging assembly at least partially disposed within the housing portion and permanently coupled thereto, the charging assembly comprising an outlet connector projecting rearwardly through one or more openings in a back surface of the housing and a data and/or power exchanging device.

2. The wall plate system of claim 1, wherein the outlet connector comprises a one or multi-prong plug.

3. The wall plate system of claim 1, wherein the outlet connector comprises a USB connector.

4. The wall plate system of claim 1, wherein the data and/or power exchanging device comprises a cord having a distal connector, the cord projecting forwardly from a front surface of the housing.

5. The wall plate system of claim 4, further comprising a cord protector mounted to the housing around the opening in the front surface.

6. The wall plate system of claim 4, wherein the housing portion projects forwardly from the plate portion and further comprises a flange projecting outwardly from a sidewall thereof.

7. The wall plate system of claim 6, wherein a portion of the flange is parallel with the wall plate.

8. The wall plate system of claim 6, wherein the flange further comprises one or more slot openings sized to frictionally receive a portion of the cord therein.

9. The wall plate system of claim 1, wherein the data and/or power exchanging device comprises a transmitter coil disposed within the housing portion and having a main surface extending generally parallel with a charging surface of the housing portion.

10. The wall plate system of claim 9, wherein the housing portion extends forwardly from the plate portion in a generally horizontal orientation such that the charging surface faces upwardly to receive a portable electronic device thereon.

11. The wall plate system of claim 9, wherein the housing portion extends upwardly from the plate portion; and the wall plate further comprises a ledge extending forwardly from the housing portion to receive a portable electronic device thereon.

12. The wall plate system of claim 11, wherein the housing portion extends at a rearward angle with respect to a vertical axis of the plate portion.

13. The wall plate system of claim 1, wherein the data and/or power exchanging assembly comprises a converter.

14. The wall plate system of claim 1, wherein the data and/or power exchanging assembly comprises a switch mode power supply.

15. The wall plate system of claim 1, wherein the wall plate further comprises a socket opening, the housing portion and socket opening configured to align with respective sockets of an electrical outlet.

16. The wall plate system of claim 1, wherein the wall plate further comprises a fastener opening extending therethrough to secure the wall plate to an electrical outlet or structure adjacent to an electrical outlet.
